(19) United States
(12) Patent Application Publication
(10) Pub. No.: US 2010/0046877 A1
(43) Pub. Date: Feb. 25, 2010

(54) ROLLING ELEMENT BEARING WITH REDUCED CAGE POCKET CLEARANCE

(75) Inventors: Alfred Pecher, Stadtlauringen (DE); Karl Bywalez, Schweinfurt (DE); Joachim Schleifenbaum, Niederwerrn (DE); Henri Van Der Knokke, Niederwerrn (DE); Manfred Fuchs, Gaedheim (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/301,831

(22) PCT Filed: May 22, 2007
(86) PCT No.: PCT/DE2007/000925

§ 371 Date: Feb. 18, 2009

(30) Foreign Application Priority Data
May 24, 2006 (DE) 10 2006 024 375.7

(51) Int. Cl. F16C 33/48

(52) U.S. Cl. 384/572

(57) ABSTRACT

The invention relates to a rolling element bearing comprising a cage with cage pockets for guiding rolling elements which are guided in the cage pockets with an axial play at least in the axial direction of the rolling element bearing, thereby defining an axial cage pocket clearance. The invention is characterized in that the cage pocket clearance in a plurality of cage pockets ranges between 0.07 millimeter and 0.17 millimeter.

### FIELD OF THE INVENTION

The invention relates to a rolling element bearing with a cage for guiding the rolling elements.

Rolling element bearings, in specific operating states, cause increased running noise which in many applications is disturbing or even rules out their use. In rolling element bearings with a cage consisting of sheet metal or of laminated fabric for guiding the rolling elements, the noises are caused, in particular, by an exciting of the cage by the rolling elements.

DE 197 81 320 B4 discloses a reduced-noise rolling element bearing with a raceway which is designed as a composite hollow ring. The hollow ring consists of a first ring part, which is in contact with the rolling elements, and of a second ring part, which surrounds the first ring part. Between the ring parts is formed a gap which is filled with oil or with another fluid. The track of the first ring part deviates partially from the circular shape due to one or more elastic track curvatures. At any point in time, some rolling elements are pretensioned, and therefore the mounted shaft likewise acquires radial pretension. The shaft therefore has only a slight possibility of proper motion, so that the generation of noise is reduced. This solution has the disadvantage of the high outlay necessary for mounting the fluid-filled gap. The fluid must be under pressure, for which purpose corresponding sealing measures are required. A further disadvantage is that, on account of the pretension, the rolling friction of the rolling elements on the raceways is increased. Moreover, the noise occurring due to the interaction between the cage and the rolling elements is damped only insignificantly.

For noise reduction, as is known, for example, from EP 1 083 353 A2, special greases are also used which exhibit a damping action. However, because of their low temperature resistance, these greases cannot be used at higher bearing temperatures.

Cages in rolling element bearings according to the prior art have the problem that, in specific operating states, they are regularly excited by the rolling elements such that, in addition to rotation according to function, they also perform oscillations particularly in the radial direction. As soon a rolling element bearing has reached such an operating state, it generates a permanent operating noise, the oscillation of the cage affording the greatest proportion of this. The oscillation of the cage can be transmitted to further parts of the rolling element bearing and of the machine, with the result that increased wear can occur.

The object of the present invention, therefore, is to provide a rolling element bearing with a cage, the operating noise of which is lowered by means of a measure which is simple to implement, without the rolling friction of the rolling elements being appreciably increased.

This object is achieved by means of a rolling element bearing according to the accompanying claim 1.

The invention is based on the realization that the noise-generating oscillation of the cage is caused, inter alia, by too great a play of the rolling elements in the cage pockets. In this case, in particular, the play of the rolling elements in the cage pockets in the axial direction with respect to the rolling element bearing is significant. The play of the rolling elements in the cage pockets causes an air layer between the rolling elements and the cage pockets, which is also designated as cage pocket clearance.

In rolling element bearings according to the prior art, a cage pocket clearance in the axial direction of about 0.2 millimeters is formed. This value applies to rolling element bearings of many construction sizes, in particular to ball bearings. Insofar as, in the play between the rolling elements and the cage pockets, surface portions of the rolling elements and of the cage pockets stand opposite one another and can act, unimpeded, one on the other, a cage pocket clearance will be formed over the width of the play between the rolling elements and the cage pockets. This is the case, as a rule, in the standard forms of construction of rolling element bearings, in particular of the abovementioned ball bearings. Lubricant may also be present in the region of the cage pocket clearance.

It is essential to the invention, first, that the rolling elements, for example balls, are guided with play in the axial direction in the cage pockets of the cage in such a way as to form a cage pocket clearance in the axial direction which at least in the case of a plurality of the rolling elements, preferably all rolling elements, has a value from a range of between 0.07 millimeters and 0.17 millimeters.

Particular advantage of the invention is that, by a structural variation which is simple to implement, as great a reduction as possible of the noises occurring in the region of the cage of a rolling element bearing is achieved. No additional components or structural additions which would increase the outlay in terms of the production of a rolling element bearing according to the invention are required.

In the rolling element bearing according to the invention, there is no noise-generating oscillating of the cage, or, at least, there is a marked noise reduction, since the cage pocket clearance in the axial direction is reduced. This prevents an oscillation of the cage particularly in the radial direction.

The implementation according to the invention of the cage pocket clearance in the axial direction in the range of 0.07 millimeters to 0.17 millimeters prevents the noise-generating oscillation of the cage, a low-friction rolling movement of the rolling elements in the cage pockets being ensured.

The reduction according to the invention in the axial cage pocket clearance may be applied to any desired cage forms and any desired rolling element forms.

Any cage pocket form, for example a dome-shaped form, a box form or a frame form, causes an axial guidance of the rolling elements, guidance requiring a play, and, consequently, a cage pocket clearance in the axial direction being capable of being formed. According to the invention, the cage pocket clearance has the specified dimension, within the framework of customary tolerances, in a plurality of the cage pockets. Preferably, the cage pocket clearance has the specified dimension, within the framework of customary tolerances, in all the cage pockets of the rolling element bearing.

In a particularly preferred embodiment, the cage pocket clearance in the axial direction has a value in the range of 0.09 millimeters to 0.11 millimeters, since this dimension constitutes an optimum.

The implementation according to the invention of the cage pocket clearance in the axial direction with a value in the range of 0.07 millimeters to 0.17 millimeters is also largely independent of the size of the rolling element bearing, since the absolute dimension of the radius of the rolling element and the absolute dimension of the radius of the cage pockets which is dependent on this have scarcely any influence on the problem of the oscillation of the cage which is solved by means of the invention.

The cage pocket clearance in the radial direction with respect to the rolling element bearing is preferably likewise reduced, as compared with the dimension known to the prior art. In particular, the (reduced) radial cage pocket clearance is a geometric function of the (reduced) axial cage pocket clearance. The cage pocket clearance in at least a plurality of the cage pockets preferably has a value of between 0.3 millimeters and 0.6 millimeters in the radial direction. It amounts particularly preferably to between 0.35 millimeters and 0.45 millimeters.

Particularly preferably, the rolling element bearing is designed as a ball bearing and the rolling elements are designed as balls, in particular the balls having a diameter Dw with a value from a range of between 5 mm and 25 mm.

Further advantages, details and developments of the invention may be gathered from the following description of a plurality of embodiments, with reference to the drawings in which:

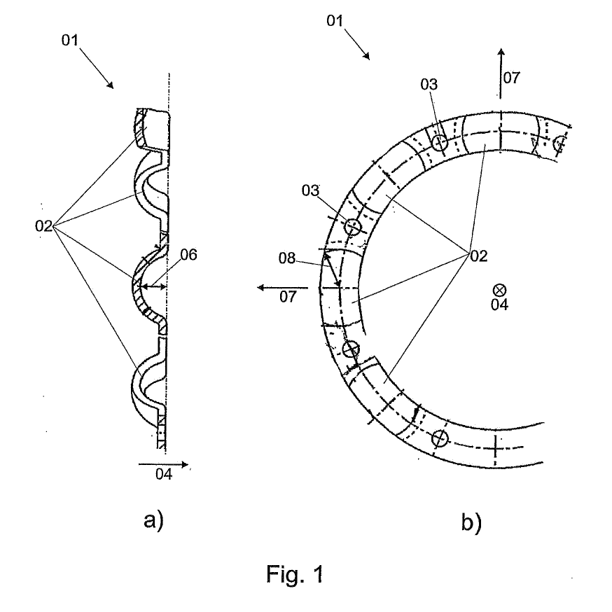

FIG. 1 shows two views of a cage of a rolling element bearing according to the invention;

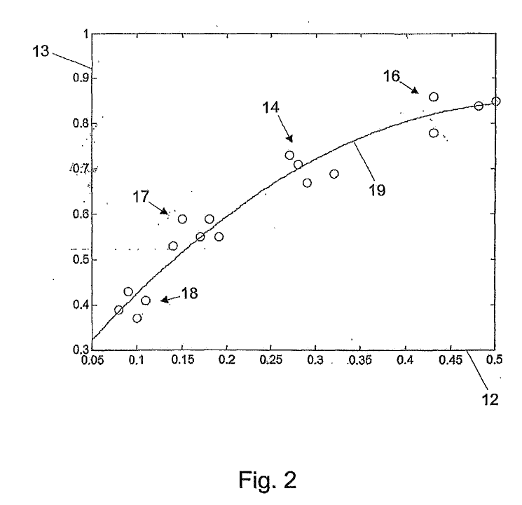

FIG. 2 shows a graph to illustrate the dependence of the cage noise on the axial and the radial cage pocket clearance.

FIG. 1 shows two views of a cage 01 of a rolling element bearing according to the invention. Picture a) of FIG. 1 shows a sectional side view of a portion with four pockets of a cage half of the cage 01. Picture b) of FIG. 1 shows a top view of the portion with four pockets of the cage half of a cage 01.

The half of the cage 01 which is shown in FIG. 1 serves for guiding eight balls (not shown) which function as rolling elements in a ball bearing. The cage 01, for this purpose, has eight dome-shaped cage pockets 02. Between the cage pockets 02, holes 03 are arranged in the cage 01 for leading through rivets or other connection means (not shown). To assemble the ball bearing, the eight balls are arranged between the two halves of the cage, and the two halves of the cage 01 are connected to one another by means of eight rivets.

The eight cage pockets 02 are distributed uniformly over the ring-shaped cage 01. Consequently, the center points of the cage pockets 02 are in each case at an angle of 45 degrees to one another. The dome-shaped cage pockets 02 are designed to be slightly larger than the balls, so that the balls are guided with play in the cage pockets 02. The play allows a free rolling of the balls in the cage 01. Furthermore, preferably, a lubricant is located in the interspaces between the balls and the cage pockets 02, so that the balls can roll with low friction in the cage pockets 02.

The dome-shaped form of the cage pocket 02 has an axial radius 06 in the direction 04 of the axis of the rolling element bearing. The resulting axial diameter is designed to be larger than the diameter of the balls. In the preferred embodiment, the difference between these two diameters amounts to 0.1 mm and is equal to the cage pocket clearance in the axial direction 04.

The dome-shaped form of the cage pockets 02 does not have an identical radius in all directions, but, instead, corresponds approximately to the form of a cut ellipsoid. The ellipsoid has different radii in the major axes. In a radial direction 07 with respect to the rolling element bearing, the guidance of the balls in the cage 01 is determined by a radial radius 08 of the cage pockets 02. The radial radius 08 is designed to be larger than the radius of the balls in such a way as preferably to form a cage pocket clearance with a value of 0.4 mm in the radial direction 07.

FIG. 2 shows a graph to illustrate the dependence of the rolling element bearing noise on the axial and the radial cage pocket clearance. The value of the axial cage pocket clearance is plotted in millimeters on an x-axis 12 of the graph. The value of the radial cage pocket clearance is plotted in millimeters on a y-axis 13 of the graph. The measurements illustrated in the graph were conducted for a ball bearing of type 6310 according to DIN 625-1. Since the causes of the generation of noise depend scarcely at all on the absolute dimensions of the cage and of the rolling elements, the measurement results shown can, in principle, be transferred to other types of rolling element bearings.

Seventeen measurement results, which are illustrated in each case by a small circle, are entered in the graph. The rolling element bearings investigated can be divided into four groups. A first group 14 of four rolling element bearings corresponds to the prior art, these rolling element bearings having the known operating noise. The axial cage pocket clearance of these rolling element bearings is about 0.25 millimeters to 0.3 millimeters. The radial cage pocket clearance amounts to about 0.7 millimeters.

Rolling element bearings with an even greater axial and radial cage pocket clearance generate an even louder operating noise. In a second group 16 of four rolling element bearings, the axial cage pocket clearance is about 0.4 millimeters to 0.5 millimeters and the radial cage pocket clearance amounts to about 0.8 millimeters. These rolling element bearings generate a loud cage noise.

In rolling element bearings with reduced axial and radial cage pocket clearance, the operating noise is reduced. A third group 17 of five rolling element bearings has an axial cage pocket clearance of about 0.14 millimeters to 0.20 millimeters and a radial cage pocket clearance of about 0.5 millimeters to 0.6 millimeters. These rolling element bearings generate only a slight cage noise.

A fourth group 18 of four rolling element bearings according to the invention has an axial cage pocket clearance of about 0.08 millimeters to 0.11 millimeters and a radial cage pocket clearance of about 0.37 millimeters to 0.43 millimeters. The rolling element bearings according to the invention of the fourth group 18 generate no measurable operating noise originating from the cage.

A curve 19 illustrates the mathematical relation, determined with the aid of regression, between the thickness x of the axial cage pocket clearance and the thickness y of the radial cage pocket clearance. This relation can be described approximately by the formula y=−2.2 * x²+2.4 * x+0.21.

### LIST OF REFERENCE SYMBOLS

01 Cage

02 Cage pocket

03 Rivet hole

04 Axial direction

05

06 Axial radius of the cage pockets

07 Radial direction

08 Radial radius of the cage pockets

09

10

11

12 x-axis

13 y-axis

14 First group of rolling element bearings

15

16 Second group of rolling element bearings

17 Third group of rolling element bearings

18 Fourth group of rolling element bearings

19 Curve

1. A rolling element bearing comprising: a cage with cage pockets for the guidance of rolling elements which are guided in the cage pockets with an axial play at least in the axial direction of the rolling element bearing, with the result that an axial cage pocket clearance is provided, wherein the axial cage pocket clearance in a plurality of the cage pockets has a value in a range of between 0.07 millimeters and 0.17 millimeters.

2. The rolling element bearing as claimed in claim 1, wherein the rolling elements are guided in the cage pockets with a radial play in the radial direction of the rolling element bearing, with the result that a radial cage pocket clearance is provided, which in a plurality of the cage pockets has a value of between 0.30 millimeters and 0.60 millimeters.

3. The rolling element bearing as claimed in claim 1, wherein the radial cage pocket clearance is a geometric function of the axial cage pocket clearance.

4. The rolling element bearing as claimed in claim 1, wherein the axial cage pocket clearance in a plurality of the cage pockets has a value of between 0.09 millimeters and 0.11 millimeters.

5. The rolling element bearing as claimed in claim 2, wherein the radial cage pocket clearance in a plurality of the cage pockets has a value of between 0.35 millimeters and 0.45 millimeters.

6. The rolling element bearing as claimed in claim 1, wherein the axial cage pocket clearance in all the cage pockets has the same value.

7. The rolling element bearing as claimed in claim 2, wherein the radial cage pocket clearance in all the cage pockets has the same value.

8. The rolling element bearing as claimed in claim 1, wherein all the rolling elements are designed as balls of equal size, in that the cage pockets possess ellipsoidal inner surfaces, and in that the thickness of the axial cage pocket clearance corresponds to the difference between the diameter of the ellipsoid in the axial direction and the diameter of the balls.

9. The rolling element bearing as claimed in claim 7, wherein the radial cage pocket clearance corresponds to the difference between the diameter of the ellipsoid in the radial direction and the diameter of the balls.

10. The rolling element bearing as claimed in claim 1, wherein the cage is formed in one piece or in the plurality of pieces, in particular consists of two complementary cage halves which are connected at connection points between the individual cage pockets by connection means.

11. The rolling element bearing as claimed in claim 9, wherein the cage consists of sheet metal, plastic, brass or laminated fabric.

12. The rolling element bearing as claimed in claim 1, wherein the rolling element bearing is designed as a ball bearing and the rolling elements are designed as balls, in particular the balls having a ball diameter Dw with a value from a range of between 5 mm and 25 mm.
